(19) United States
(12) Patent Application Publication
(10) Pub. No.: US 2007/0283158 A1
(43) Pub. Date: Dec. 6, 2007

(54) System and method for generating a forensic file

(75) Inventor: Michael S. Danseglio, Redmond, WA (US)

Correspondence Address: MICROSOFT CORPORATION, ONE MICROSOFT WAY, REDMOND, WA, 98052-6399, US

(73) Assignee: Microsoft Corporation Microsoft Patent Group, Redmond, WA (US)

(21) Appl. No.: 11/445,803

(22) Filed: Jun. 2, 2006

(51) Int. Cl. H04L 9/00

(52) U.S. Cl. 713/180

(57) ABSTRACT

A file having a data structure is provided which includes copied information, a first hash value, and a second hash value. The file can be generated by copying original information from an information source, performing a first hash operation on the copied information to generate the first hash value, and performing a second hash operation on the copied information and the first hash value to generate the second hash value. The first hash value proves integrity of the copied information with respect to the original information, and the second hash value proves integrity of the first hash value. Because the second hash value is based on a cryptographic hash of the first hash value and the copied information, the second hash value simultaneously allows authenticity of copied information and the first hash value to be confirmed. If either the copied information or the first hash value is changed, the second hash value will no longer match the first hash value.

### BACKGROUND

This description relates generally to copying information, and more specifically to techniques for verifying authenticity of copied information.

When a computer is identified as possibly containing electronic evidence, it is imperative to follow a strict set of procedures to ensure a proper (e.g., admissible) extraction of any evidence that may exist on the subject computer. For example, in one context, when a law enforcement officer executes a search warrant at a property which has a computer on site, the law enforcement officer will typically just shut off the power to the computer and take the computer back to the police department where it sits for a period of time before it is examined.

Sometime later a forensic investigator begins a forensic investigation of the computer, during which the forensic investigator creates an image of computer's original hard drive. Before the investigator analyzes any information on the seized computer hard drive (or other storage media such as floppy disk(s), CD(s), Zip drive(s) or DVD(s), or any of the many other types of storage media that now exist), the investigator takes the hard drive out of the computer, and connects the hard drive to a duplicator device which duplicates an image of the hard drive into a file. The duplicator creates a “bit level” or bit-by-bit copy of all data on a hard drive, and saves it in a file on another hard drive or other storage media such as CDs, DVDs and smaller hard drives. This copy is sometimes called an “image copy,” and includes every bit of information on the hard drive regardless of whether or not it is part of an existing file system.

Using this image copy, the investigator can conduct an in-depth analysis without fear of altering the original evidence. For instance, the investigator may use the image copy to reconstruct the entire contents of the hard drive and detail recent activities performed on the computer. These imaging methods are often used in forensic examinations of the data in, for example, the context of law enforcement and policy compliance verification. Suggested protocols for hard drive imaging can be found within guidelines standardized by institutions and organizations like the Department of Justice (DOJ) and the National Institute of Standards and Technology (NIST).

The forensic investigator making the image copy must make sure that the integrity of all evidence is maintained, and that a chain of custody is established. Once imaging is completed, to avoid accusations of evidence tampering or spoliation, digital fingerprints (called cryptographic “hashes”) of the original data source and the image copy can be generated. These “hashes” can be used to verify that the original data source and/or the image copy have not been modified.

For example, once an image copy has been made, to ensure that it was made correctly (e.g., that the copy is exactly the same as the original), a hashing algorithm can be used to create a large number called a digital fingerprint (sometimes referred to as a “message digest” or “hash”). A hash generation process involves examining all of the 0's and 1's that exist across the sectors examined. Altering a single 0 to a 1 in the examined sectors will cause the resulting hash value to be different, and altering any part of the hash value will invalidate it. Both the original and copy of the evidence are analyzed to generate a source hash value corresponding to the original data source and a target hash value corresponding to the image copy. If the hash value is the same for both, the image copy is considered authentic.

For example, once an image copy has been made, to ensure that it was made correctly (e.g., that the copy is exactly the same as the original), a hashing algorithm can be used to create a large number called a digital fingerprint (sometimes referred to as a “message digest”).

A commonly used hashing algorithm is the message digest (MD)-5 algorithm. The MD5 algorithm takes as input a message of arbitrary length and produces a condensed 128-bit value, sometimes referred to as a “fingerprint” or “message digest,” which corresponds to the input. For example, the investigator will typically use an MD5 algorithm to create an MD5 hash value of the information stored on the original hard drive, and will also create another MD5 hash value of the information stored in the image copy when the image copy of the hard drive is created. In other words, the investigator takes an MD5 hash of the hard drive, which generates a first hash value, and then also takes an MD5 hash of the image copy, which also generates the second hash value. The “message digest” can allow the integrity of the input information to be verified.

The MD5 algorithm is generally accepted as a method of verifying the integrity of data. An MD5 hash value obtained from the image copy of the hard drive must match the MD5 hash value of the original hard drive. If the two MD5 hash values match, then it is presumed that that there is reasonable assurance of the authenticity of the copied hard drive or other media (e.g., the image data is an exact identical copy of the original data stored on the hard drive; the original data on the hard drive and the data on the image copy of that hard drive are identical data). If the disk contents are to be altered in any way, through deleting or changing a file for example, running the MD5 algorithm can result in a radically different message digest. This is true regardless of the extent of the alterations made; even the smallest modification on a hard drive (e.g., a change to one bit of information on a large drive packed with data, such as adding a comma to a document) would result in a new, vastly different message digest (or resulting MD5 hash value).

After the forensic investigator conducts their investigation based on the image copy they have created, the forensic investigator will inevitably be asked to confirm the authenticity of the data (e.g., does the content that was examined in the image correspond to the content of the original hard drive which was seized by the police). If the forensic investigator can prove that the image of the hard drive has not been disturbed during examination, then courts will generally accept the image copy as being the equivalent of the original hard drive evidence. Courts have traditionally accepted this mechanism to allow the forensic investigator to verify that the image copy is identical to the original copy. In other words, showing that the MD5 hash of the hard drive and the MD5 hash of the image copy are identical is an accepted technique for proving that the image copy has not been altered or manipulated and is the same unmolested or unchanged data that was present on the hard drive of the seized computer.

However, one flaw of such imaging techniques is that there is no secure way of storing the hash value which corresponds to the original hard drive information and the hash value which corresponds to the image copy. For example, the investigator typically writes the hash values down in a notebook or stores the hash value in a file on a computer for future use. As such, the hash values could easily be changed because the paper notes or computer files are not secure or protected against tampering. For instance, an attacker could modify the hash values stored in a notebook to correspond to a new MD5 hash for the hard drive after the hard drive was modified, altered or changed in some way thereby effectively covering his tracks. Accordingly, there is a potential problem in that the evidence could be tampered with and there is no actual assurance that the image copy is authentic (e.g., that an image copy made is an exact replica of the original hard drive).

### SUMMARY

Techniques are provided for simultaneously proving the authenticity of data and its cryptographic hash. A forensic file format is provided which can simultaneously allow the authenticity of both copied data and its cryptographic hash to be confirmed. This file format includes a first hash value of actual copied data, and cryptographically protects the stored first hash value against modification by cryptographically hashing or signing the first hash value and the data to produce a second hash value. This file format can therefore prevent tampering because an attacker would be unable to modify the second hash value.

According to one exemplary implementation, a file having a data structure is provided which includes copied information, a first hash value, and a second hash value. The file can be generated by copying original information from an information source, performing a first hash operation on the copied information to generate the first hash value, and performing a second hash operation on the copied information and the first hash value together to generate the second hash value. The first hash value proves integrity of the copied information with respect to the original information, and the second hash value proves integrity of the first hash value. Because the second hash value is based on a cryptographic hash of the first hash value and the copied information, the second hash value simultaneously allows authenticity of copied information and the first hash value to be confirmed. If either the copied information or the first hash value is changed, the second hash value will no longer match the first hash value.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

The techniques and technologies for generating a file comprising copied data, a first hash value, and a second hash value are further described with reference to the accompanying drawings in which:

FIG. 1 thus illustrates an example of a computing system environment;

FIG. 2 is a simplified block diagram of a file generator module in accordance with an exemplary embodiment;

FIG. 3 is a block diagram of a file having a generic forensic encapsulated file format (FEFF) data structure in accordance with an exemplary embodiment;

FIG. 4 is a simplified block diagram of an unkeyed file generator module in accordance with yet another exemplary embodiment;

FIG. 5 is a block diagram of a file having an unkeyed FEFF data structure in accordance with another exemplary embodiment;

FIG. 6 is a simplified block diagram of a keyed file generator module in accordance with yet another exemplary embodiment;

FIG. 7 is a block diagram of a file having a keyed FEFF data structure in accordance with yet another exemplary embodiment; and

FIG. 8 illustrates an exemplary non-limiting flow diagram for generating a file having a FEFF data structure.

### DETAILED DESCRIPTION

The following detailed description is merely exemplary in nature and is not intended to limit the invention or the application and uses of the invention. As used herein, the word “exemplary” means “serving as an example, instance, or illustration.” Any implementation described herein as “exemplary” is not necessarily to be construed as preferred or advantageous over other implementations. All of the implementations described below are exemplary implementations provided to enable persons skilled in the art to make or use the invention and are not intended to limit the scope of the invention which is defined by the claims.

### Exemplary Computing System Environment

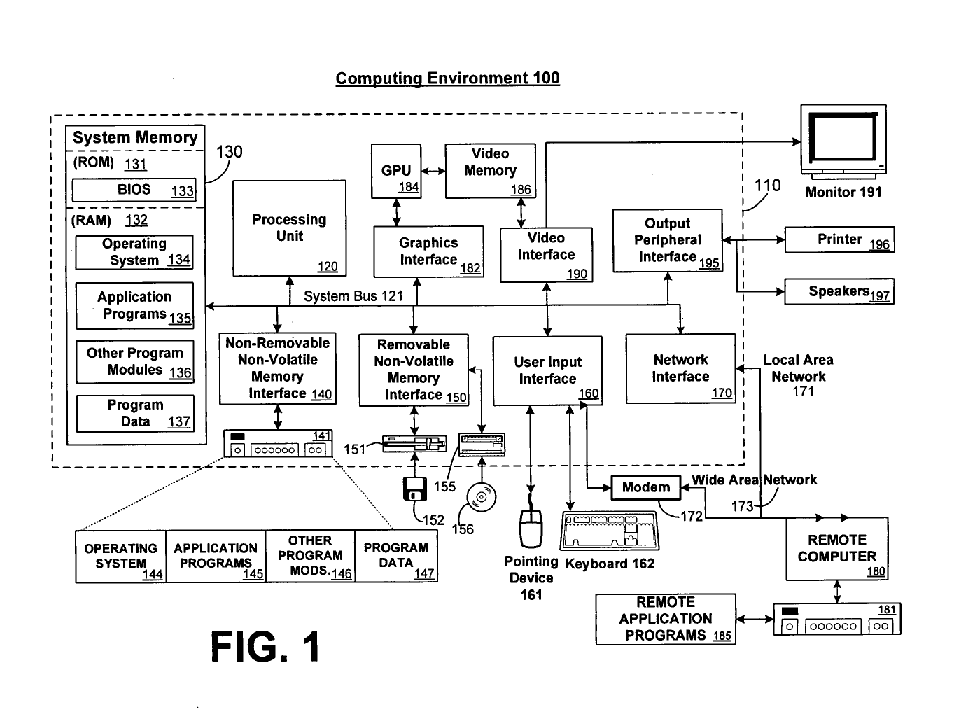

FIG. 1 illustrates an exemplary computing system environment 100. The computing system environment 100 is only one example of a computing environment, and suitable computing environments can include any general purpose computing device including those in the form of a computer 110.

Components of computer 110 may include, but are not limited to, a processing unit 120, a system memory 130, and a system bus 121 that couples various system components including the system memory 130 to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus (also known as Mezzanine bus).

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes volatile and nonvolatile media, removable and non-removable media which can be implemented in any method or technology for storage of information such as computer readable instructions, data structures, program modules or other data. Computer storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store information accessed by computer 110.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A-basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156, such as a CD-ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1 provide storage of computer readable instructions, data structures, program modules and other data for the computer 110. In FIG. 1, for example, hard disk drive 141 is illustrated as storing operating system 144, application programs 145, other program modules 146 and program data 147. Note that these components can either be the same as or different from operating system 134, application programs 135, other program modules 136 and program data 137. Operating system 144, application programs 145, other program modules 146 and program data 147 are given different numbers here to illustrate that, at a minimum, they are different copies.

A user may enter commands and information into the computer 110 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus 121, but may be connected by other interface and bus structures, such as a parallel port, game port or a universal serial bus (USB). A graphics interface 182, such as Northbridge, may also be connected to the system bus 121. Northbridge is a chipset that communicates with the CPU, or host processing unit 120, and assumes responsibility for accelerated graphics port (AGP) communications. One or more graphics processing units (GPUS) 184 may communicate with graphics interface 182. In this regard, GPUs 184 generally include on-chip memory storage, such as register storage and GPUs 184 communicate with a video memory 186.

A monitor 191 or other type of display device is also connected to the system bus 121 via an interface, such as a video interface 190, which may in turn communicate with video memory 186. In addition to monitor 191, computers may also include other peripheral output devices such as speakers 197 and printer 196, which may be connected through an output peripheral interface 195.

The computer 110 may operate in a networked or distributed environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks/buses. Such networking environments are commonplace in homes, offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

### Exemplary Hash Function Technologies

As used herein, the term “hash function” refers to a form of cryptography that takes input information and transforms it into a fixed-length output called a message digest. The digest is a fixed-size set of bits that serves as a unique “digital fingerprint” for the original message. The resulting message digest is a fixed size. A hash of a short message will produce the same size digest as a hash of a full set of encyclopedias. If the original message is altered and hashed again, it will produce a different signature. Thus, hash functions can be used to detect altered and forged documents. They provide message integrity, assuring recipients that the contents of a message have not been altered or corrupted. Hash functions are one-way, meaning that it is easy to compute the message digest but very difficult to revert the message digest back to the original input information. An analogy might be that a fingerprint can be obtained from a person, but a person can not reconstructed from that fingerprint Ideally it should be impossible for two different useful messages to ever produce the same message digest. Changing a single digit in one message will produce an entirely different message digest. Ideally it should be impossible to produce a message that has some desired or predefined output (target message digest). A message digest should also be impossible to reverse because the message digest could have been produced by an almost infinite number of messages.

For example, a “hash function” can refer to a transformation that takes a variable-size input m and returns a fixed-size string, which is called the hash value h (that is, h=H(m)). Hash functions with just this property have a variety of general computational uses, but when employed in cryptography the hash functions are usually chosen to have some additional properties.

For a cryptographic hash function: the input can be of any length, the output has a fixed length, H(x) is relatively easy to compute for any given x, H(x) is one-way, and H(x) is collision-free. A hash function H is said to be one-way if it is hard to invert, where “hard to invert” means that given a hash value h, it is computationally infeasible to find some input x such that H(x)=h. If, given a message x, it is computationally infeasible to find a message y not equal to x such that H(x)=H(y) then H is said to be a weakly collision-free hash function. A strongly collision-free hash function H is one for which it is computationally infeasible to find any two messages x and y such that H(x)=H(y).

A wide variety of hash functions or algorithms are commonly used in cryptography. Some of these include, for example, message-digest (MD) hash functions MD2, MD4, and MD5, used for hashing digital signatures into a shorter value called a message-digest. As used herein, the term “MD5” refers to a hash function algorithm that is used to verify data integrity through the creation of a 128-bit output known as a “message digest” from data input (which may be a message of any length). MD5 is intended for use with digital signature applications, which require that large files must be compressed by a secure method before being encrypted with a secret key, under a public key cryptosystem. MD5 is described in Internet Engineering Task Force (IETF) Request for Comments (RFC) 1321. According to the standard, it is “computationally infeasible” that any two messages that have been input to the MD5 algorithm could have as the output the same message digest, or that a false message could be created through apprehension of the message digest.

A Secure Hash Algorithm (SHA) that is similar to MD4 and makes a larger (60-bit) message digest. As used herein, the term “Secure Hash Algorithm (SHA)” refers to a set of related cryptographic hash functions designed by the National Security Agency (NSA) and the National Institute of Standards and Technology (NIST), and is published as a US government standard sometimes referred to the Digital Signature Standard (DSS). One commonly used function in the SHA family, the Secure Hash Algorithm-1 (SHA-1), is employed in a large variety of popular security applications and protocols. SHA-1 is an MD-5-like algorithm that was designed to be used with the Digital Signature Standard (DSS). The SHA-1 algorithm produces a 160-bit message authentication code (MAC) which is considered to be more secure than MD-5. At least four more variants have since been issued, sometimes collectively referred to as SHA-2, with increased output ranges and a slightly different design: SHA-224, SHA-256, SHA-384, and SHA-512.

Other exemplary hash functions include HAVAL, Panama, RIPEMD, Snefru, and TIGER.

Keyed Hash Functions

Hash functions may be used with or without a key. If a key is used, both symmetric (single secret key) and asymmetric keys (public/private key pairs) may be used. For instance, “keyed MD5” is a technique for using MD-5 in which a sender appends a randomly generated key to the end of a message, and then hashes the message and key combination to create a message digest. Next, the key is removed from the message and encrypted with the sender's private key. The message, message digest, and encrypted key are sent to the recipient, who opens the key with the sender's public key (thus validating that the message is actually from the sender). The recipient then appends the key to the message and runs the same hash as the sender. The message digest should match the message digest sent with the message. The result of a hash function that combines a message with a key is called a message authentication code (MAC) which is a type of “fingerprint” or “message digest” of the input in combination with a key available to parties in the message exchange.

Hashed Message Authentication Code (HMAC) is a core protocol that is considered essential for security on the Internet along with IPSec, according to RFC 2316 (Report of the IAB, April 1998). It is not a hash function, but a mechanism for message authentication that uses either MD5 or SHA-1 hash functions in combination with a shared secret key (as opposed to a public/private key pair). Basically, a message is combined with a key and run through the hash function. The result is then combined with the key and run through the hash function again. This 128-bit result is truncated to 96 bits and becomes the MAC. According to RFC 2104 (HMAC: Keyed-Hashing for Message Authentication, February 1997), HMAC should be used in preference to older techniques, notably keyed hash functions. HMAC is the preferred shared-secret authentication technique, and it should be used with SHA-1. It can be used to authenticate any arbitrary message and is suitable for logins.

The following RFCs provide important additional information about the hash functions used in the Internet environment: RFC 1321 (MD5 Message-Digest Algorithm, April 1992), RFC 1828 (IP Authentication using Keyed MD5, August 1995), RFC 1864 (The Content-MD5 Header Field, October 1995), RFC 1994 (PPP Challenge Handshake Authentication Protocol (CHAP), August 1996), RFC 2069 (An Extension to HTTP: Digest Access Authentication, January 1997), RFC 2085 (HMAC-MD5 IP Authentication with Replay Prevention, February 1997), RFC 2104 (HMAC: Keyed-Hashing for Message Authentication, February 1997), RFC 2316 (Report of the IAB, April 1998), RFC 2401 (Security Architecture for the Internet Protocol, November 1998), RFC 2403 (The Use of HMAC-MD5-96 within ESP and AH, November 1998), RFC 2404 (The Use of HMAC-SHA-1-96 within ESP and AH, November 1998), RFC 2537 (RSA/MD5 KEYs and SIGs in the Domain Name System (DNS), March 1999), RFC 2831 (Using Digest Authentication as a SASL Mechanism, May 2000), and RFC 2857 (The Use of HMAC-RIPEMD-160-96 within ESP and AH, June 2000).

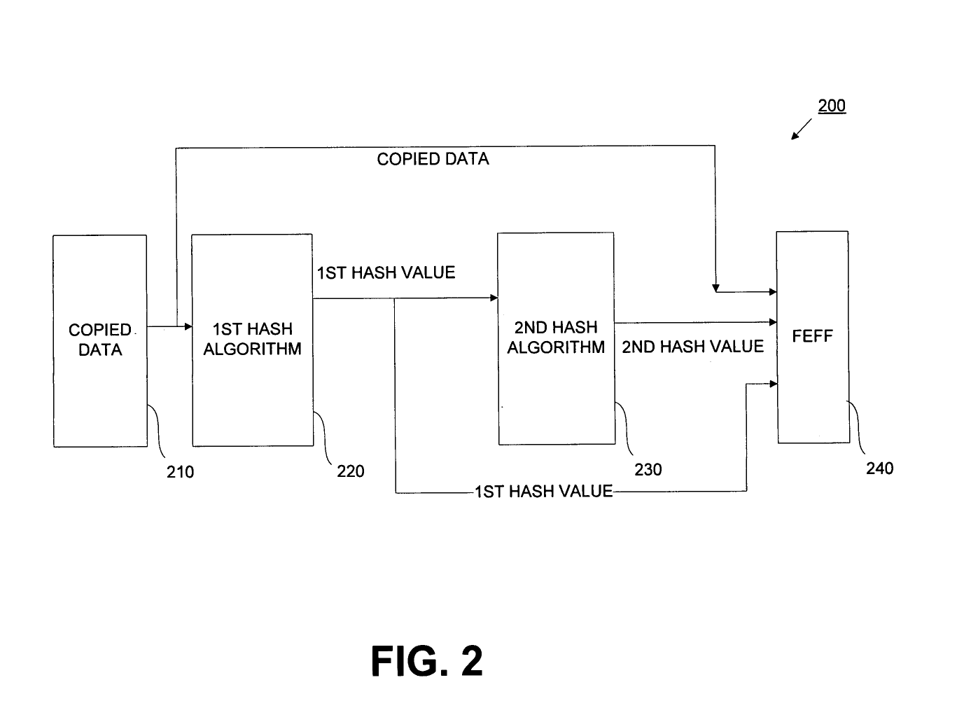

FIG. 2 is a simplified block diagram of a file generator module 200 in accordance with an exemplary embodiment.

The file generator module 200 comprises a first hash function 220 and a second hash function 230. The file generator module 200 receives copied data 210 and generates an output file 240. The copied data 210 can be any type of data copied from an information source or storage media, and may have any data format. For example, the original data 210 may comprise information stored on a computer, information stored on a memory component or other storage media, or information from a computer hard drive. In law enforcement context, for example, original data can be raw evidence data stored on a computer hard drive, and the copied data 210 may comprise hard drive image (IMG) data. The first hash function 220 receives the copied data 210, performs a first hash operation on the copied data 210 and outputs a first hash value. The second hash function 230 receives the first hash value and copied data 210, performs a second hash operation on the first hash value and outputs a second hash value. The second hash function 230 can be the same or different than the first hash function 220. The copied data 210, the first hash value and the second hash value are then assembled together as parts of an output file 240 having a generic forensic encapsulated file format (FEFF) data structure.

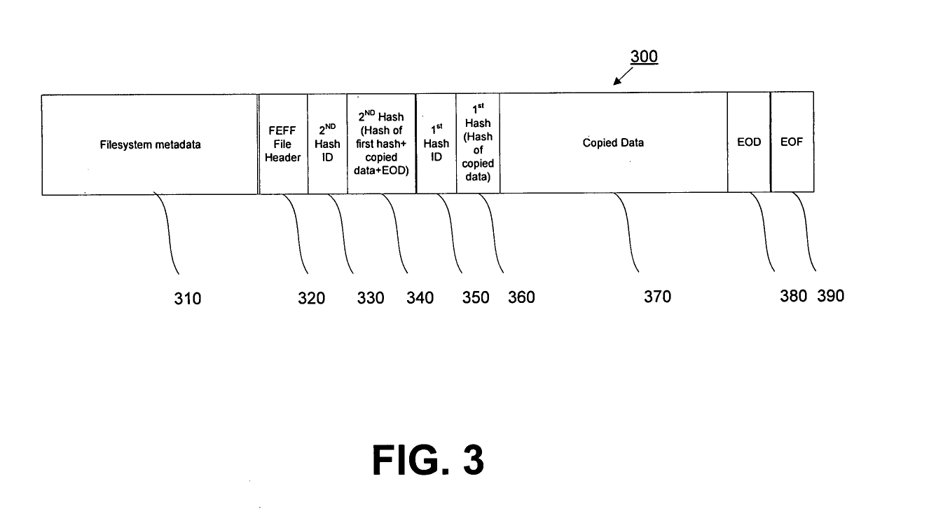

FIG. 3 is a block diagram of a file 300 having a generic forensic encapsulated file format (FEFF) data structure in accordance with an exemplary embodiment. The file 300 comprises a plurality of fields which can include, for example, a file system metadata field 310, a FEFF file header 320, a second hash ID field 330, a second hash value 340, a first hash ID field 350, a first hash value field 360, a data field 370, an end-of-data (EOD) marker 380 and an end-of-file (EOF) marker 390.

The file system metadata field 310 comprises the file system-specific data used to store the file on a mass storage device. Because FEFF is file system-independent, this can be any structure or series of structures. Metadata is “data about data” which can provide information about a specific file or document. For example, filename, size, when created, last modified, last accessed and total document editing time are all considered valuable metadata. Sometimes individuals make an effort to alter metadata. When a person tries to cover their tracks by tampering with metadata, inconsistencies across various metadata points can sometimes reveal clues of evidence tampering.

The FEFF file header 320 specifies that the remainder of the data in this file 300 is protected by FEFF. The FEFF file header 320 can be, for example, a four byte fixed length field that contains the hexadecimal data 0xFEFF.

The data field 370 comprises the copied data that is to be protected and is stored as part of the data structure inside the file 300. Ideally, the copied data is identical to the original data. This can be verified by comparing the first hash value 360 to a hash value generated for the original data.

There are two hash ID fields 330 and 350 which identify the type of hash function used to create the file. The first hash ID field 350 identifies the first hash algorithm that was used to create the hash in the next field 360. For instance, the first hash ID field 350 might indicate that the first hash algorithm was either a message-digest (MD) hash function, such as MD2, MD4, and MD5, or a Secure Hash Algorithm (SHA) such as the Secure Hash Algorithm-1 (SHA-1). The first hash ID field 330 is variable in length. The first hash value (hash of data) field 360 may comprise a nonkeyed or keyed hash of the data 370 stored in the file 300. This data can be any data in any format. This field's length varies depending on the hash algorithm used. The hash algorithm used here should be different than the previous hash algorithm. The second hash ID field 330 identifies the second hash algorithm that was used to create the hash in the next field 340. For instance, the second hash ID field 330 might indicate that the second hash algorithm was either a message-digest (MD) hash function, such as MD2, MD4, and MD5, or a Secure Hash Algorithm (SHA) such as the Secure Hash Algorithm-1 (SHA-1). The second hash ID field 330 may also contain cryptosystem-specific data such as the public key certificate used to sign the data, if appropriate. The second hash ID field 330 is variable in length. The second hash value field (hash of first hash value+data+EOD) 340 comprises a cryptographic hash of the first data-specific hash, the copied data, and the end-of-data (EOD) marker. This hash can use any hash algorithm available and can be either keyed or nonkeyed. The algorithm used to create the hash, as well as any keying material necessary to authenticate the structure, must be stored in the FEFF File Header. This field is variable in length.

The end-of-data (EOD) marker 380 indicates the end-of-data for the data. This field is maintained by FEFF. The EOD marker can be any value that the application calling FEFF desires, but by default it can be the hexadecimal value 0xFEFFFEFF. The end-of-file (EOF) marker 390 indicates the end-of-file (EOF) marker for the file 300, and is maintained by the file system.

Two specific examples of how a FEFF data structure can be used to protect computer evidence will now be described. As will be described below, the first and second hash values can be generated using either keyed hashing or unkeyed hashing.

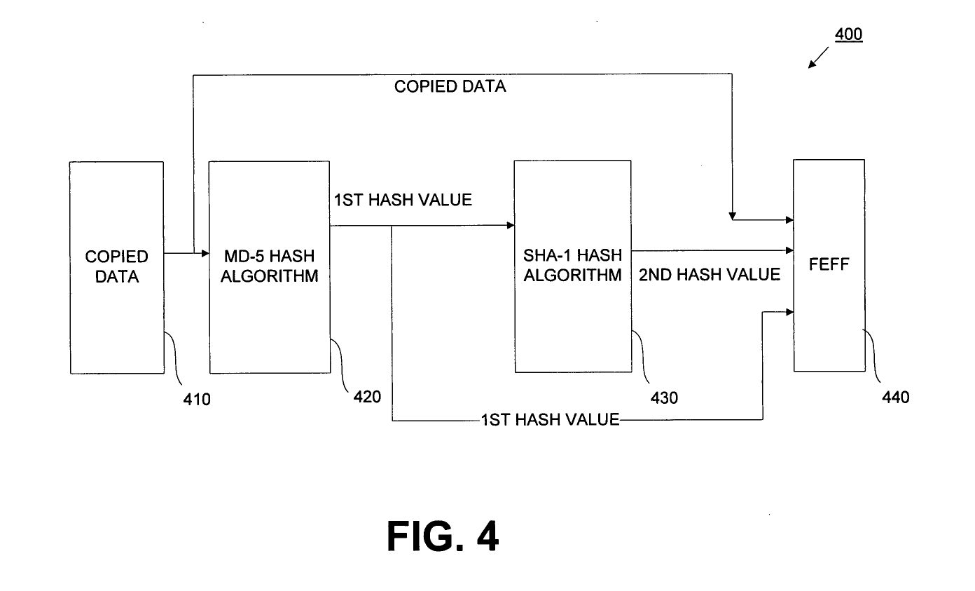

FIG. 4 is a simplified block diagram of an unkeyed file generator module 400 in accordance with yet another exemplary embodiment. The unkeyed file generator module 400 comprises a first hash function 420 and a second hash function 430. The unkeyed file generator module 400 receives copied data 410 and generates an output file 440.

The first hash function 420 receives the copied data 410, performs a first hash operation on the copied data 410 and outputs a first hash value. In this exemplary implementation, the first hash function comprises a nonkeyed, MD5 hash algorithm. The MD5 hash algorithm is used to hash and thereby protect a captured hard drive image (IMG file). Although the first hash function 420 is shown as being an MD-5 hash algorithm in this particular non-limiting exemplary embodiment, it should be appreciated that the first hash function 420 may also comprise, for example, a different message digest (MD) based hash operation, a Secure Hash Algorithm (SHA) operation such as the Secure Hash Algorithm-1 (SHA-1) operation, or any other know hash operation.

The second hash function 430 receives the copied data and, the first hash value, performs a second hash operation on the copied data and the first hash value and outputs a second hash value. In this exemplary implementation, unkeyed hashing (e.g., a straight hash of the data) is used to generate the second hash value. The second hash function 430 comprises a SHA-1 algorithm which is used to hash the MD5 hash produced by the MD5 hash algorithm, the IMG data, and the EOD field. Although the second hash function 430 is shown as being the Secure Hash Algorithm-1 (SHA-1) in this particular non-limiting exemplary embodiment, it should be appreciated that the first hash function 420 may also comprise, for example, a message digest (MD) based hash operation, another Secure Hash Algorithm (SHA) operation, or any other know hash operation.

The copied data 410, the first hash value and the second hash value are then assembled together as parts of an output file 440 having an unkeyed forensic encapsulated file format (FEFF) data structure.

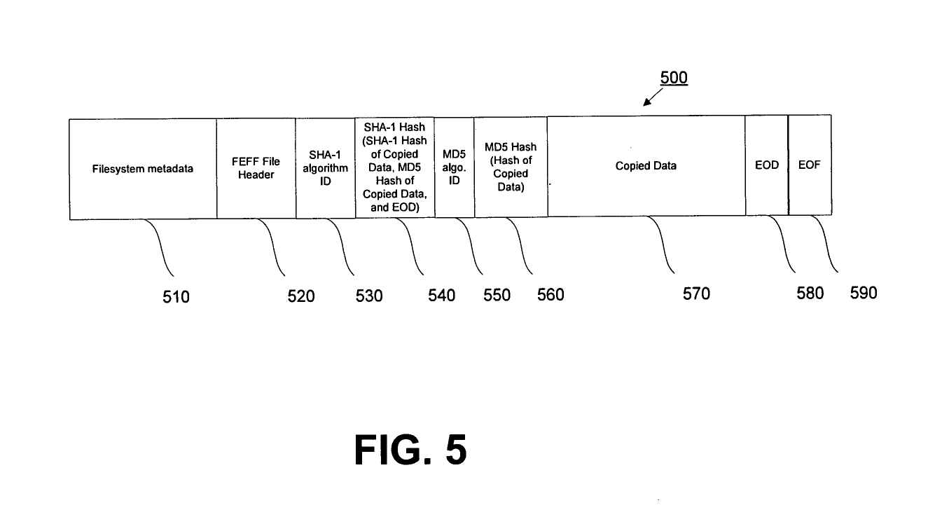

FIG. 5 is a block diagram of a file 500 having an unkeyed FEFF data structure in accordance with another exemplary embodiment.

The file 500 comprises a file system metadata field 510, a FEFF file header 520, a SHA-1 algorithm ID field 530, a SHA-1 hash value 540, a MD5 algorithm ID field 550, a MD5 hash value field 560, a data field 570 comprising a captured hard drive image (IMG file), an end-of-data (EOD) marker 580 and an end-of-file (EOF) marker 590. The file system metadata field 510, the FEFF file header 520, the data field 570, the end-of-data (EOD) marker 580 and the end-of-file (EOF) marker 590 are similar to those described above with respect to FIGS. 3, and for sake of brevity will not be described again. In FIG. 5, a nonkeyed MD5 hash algorithm is used to protect the captured hard drive image (IMG file) by using the MD5 hash algorithm to hash the IMG file and generate the MD5 hash value field 560. The SHA-1 algorithm is then used to hash the MD5 hash, the captured hard drive image (IMG file), and the EOD field 580 to produce the SHA-1 hash value field 540.

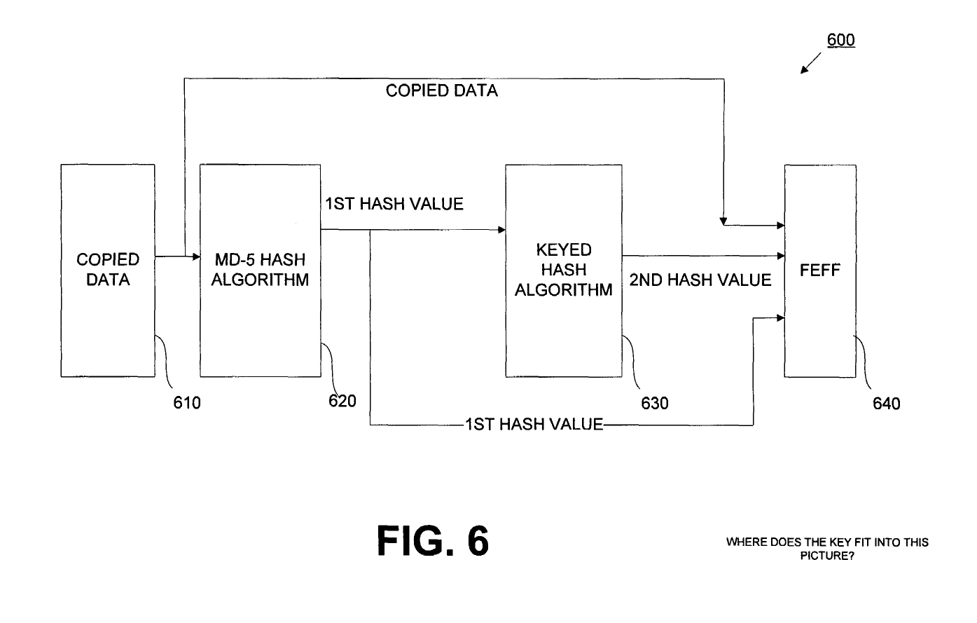

FIG. 6 is a simplified block diagram of a keyed file generator module 600 in accordance with yet another exemplary embodiment. In another embodiment, keyed hashing can be used to generate the second hash value. Keyed hashing involves combining the first hash value with a (?public or private?) key to generate the second hash value. This way the first hash value is not only signed with the second hash value but it is also signed with a public key certificate by a specific individual who has access to a (?public or private?) key.

The file generator module 600 comprises a first hash function 620 and a second hash function 630. The file generator module 600 receives copied data 610 and generates an output file 640.

The first hash function 620 receives the copied data 610, performs a first hash operation on the copied data 610 and outputs a first hash value. As above, the first hash function 620 may comprise a message digest (MD) based hash operation such as an MD-5 hash operation, a Secure Hash Algorithm (SHA) operation such as the Secure Hash Algorithm-1 (SHA-1) operation, or any other know hash operation.

The second hash function 630 receives the first hash value and a randomly generated symmetric key appropriate to the selected hash algorithm, performs a second hash operation on the first hash value and the key, and outputs a second keyed hash value. The second hash function 630 may comprise a message digest (MD) based hash operation such as an MD-5 hash operation, a Secure Hash Algorithm (SHA) operation such as the Secure Hash Algorithm-1 (SHA-1) operation, or any other know hash operation.

The copied data 610, the first hash value and the second keyed hash value are then assembled together as parts of an output file 640 which is protected via a generic forensic encapsulated file format (FEFF) data structure.

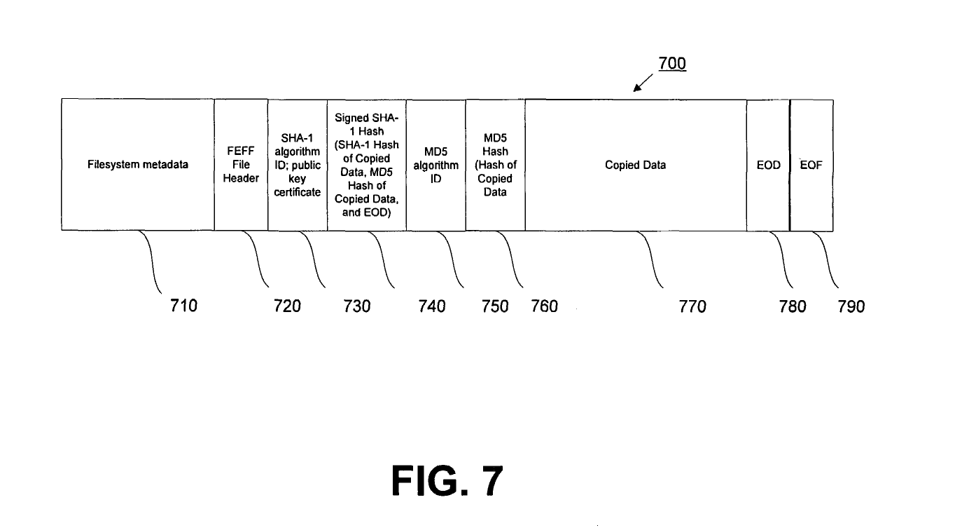

FIG. 7 is a block diagram of a file 700 having a keyed FEFF data structure in accordance with yet another exemplary embodiment. The file 700 comprises a file system metadata field 710, a FEFF file header 720, a second hash ID field 730, a second hash value 740, a first hash ID field 750, a first hash value field 760, a data field 770 comprising a captured hard drive image (IMG file), an end-of-data (EOD) marker 780 and an end-of-file (EOF) marker 790. The file system metadata field 710, the FEFF file header 720, the data field 770, the end-of-data (EOD) marker 780 and the end-of-file (EOF) marker 790 are similar to those described above with respect to FIG. 3, and for sake of brevity will not be described again.

The keyed FEFF data structure 700 uses the keyed hash method to further protect data. This not only proves the authenticity of the data, it also attaches an identity that created the digital signatures on the evidence. This attachment of identity is desirable in many law enforcement evidence processes to help prove the evidence chain of custody. In FIG. 7, an MD5 hash algorithm is used to protect the captured hard drive image (IMG file) by using the MD5 hash algorithm to hash the IMG file and generate the MD5 hash value field 760. A keyed SHA-1 algorithm is then used to hash a key, the MD5 hash 760, the captured hard drive image (IMG file), and the EOD field 580 to produce the signed SHA-1 hash value field 740. Thus, in this example, a private key is used to create a signed/keyed hash 740, and the corresponding public key certificate is included in the metadata of the SHA-1 algorithm ID 730 to provide for the verification of the MD5 hash value field 760.

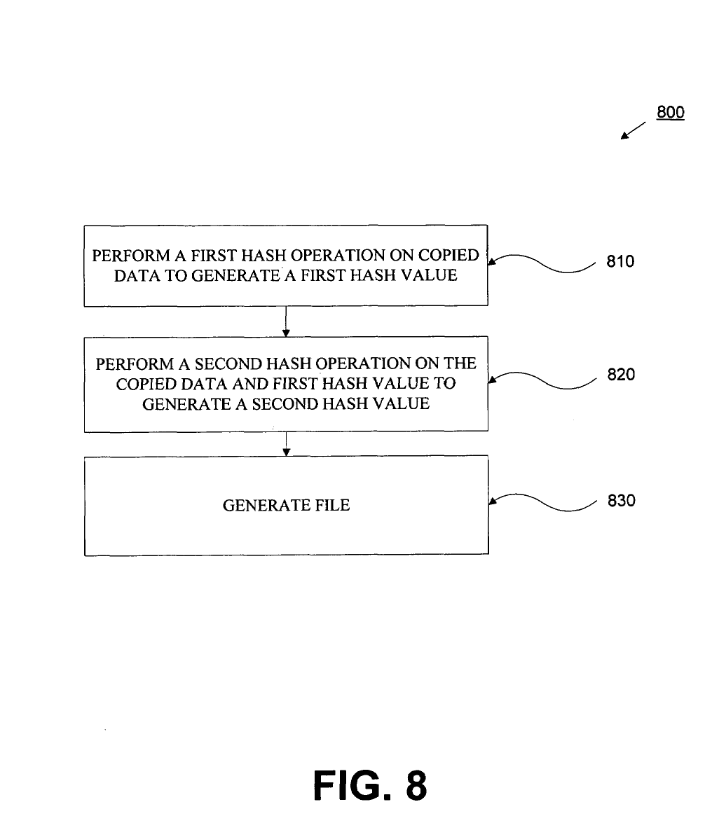

FIG. 8 illustrates an exemplary non-limiting flow diagram 800 for generating a FEFF file having a data structure comprising copied data, a first hash value, and a second hash value. At step 810, a first hash operation can be performed on the copied data to generate a first hash value based on the copied data. At step 820, a second hash operation can be performed on the copied data and the first hash value to generate a second hash value based on the copied data and the first hash value. The second hash value can be generated using either keyed hashing to generate the second hash value or an unkeyed hashing to generate the second hash value. For example, in one implementation, after creating a first MD5 hash, the first MD5 hash and the copied data can be input to a second hash function to generate a second hash value which can then be used to prove the integrity of the first hash value. At step 830, a FEFF file can be generated. The FEFF file has a data structure comprising the copied data, the first hash value, and the second hash value.

The sequence of the text in any of the claims does not imply that process steps must be performed in a temporal or logical order according to such sequence unless it is specifically defined by the language of the claim. The process steps may be interchanged in any order without departing from the scope of the invention as long as such an interchange does not contradict the claim language and is not logically nonsensical. Furthermore, numerical ordinals such as “first,” “second,” “third,” etc. simply denote different singles of a plurality and do not imply any order or sequence unless specifically defined by the claim language.

Furthermore, words such as “connect” or “coupled to” used in describing or showing a relationship between different elements do not imply that a direct connection must be made between these elements. For example, two elements may be connected to each other electronically, logically, or in any other manner, through one or more additional elements, without departing from the scope of the invention.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing the exemplary embodiments and implementations.

It should also be understood that various changes can be made in the function and arrangement of elements without departing from the scope of the invention as set forth in the appended claims and the legal equivalents thereof. For instance, any user interface (Ul), schema or algorithm would be a specific implementation of the prediction or estimation concepts described above. As such, we claim as our invention all such embodiments as may come within the scope and spirit of the following claims and equivalents thereto. Thus, the present invention is not intended to be limited to the embodiments shown herein but is to be accorded the widest scope consistent with the principles and novel features disclosed herein.

What is claimed:

1. A method for generating a file, comprising:
performing a first hash operation on copied information to generate a first hash value which proves integrity of the copied information, wherein the copied information comprises original information copied from an information source;
performing a second hash operation on the copied information and the first hash value to generate a second hash value which proves integrity of the first hash value; and
generating the file, wherein the file comprises a data structure comprising the copied information, the first hash value, and the second hash value.

2. A method according to claim 1, wherein the information source comprises a hard drive, wherein the original information comprises information from the hard drive, and wherein the copied information comprises a hard drive image file.

3. A method according to claim 1, wherein the first hash operation comprises a message-digest (MD) hash function, and wherein the first hash value comprises a first message digest.

4. A method according to claim 3, wherein the MD hash function comprises:
a MD5 hash function.

5. A method according to claim 3, wherein the second hash operation comprises:
a message-digest (MD) hash function, and wherein the second hash value comprises a second message digest which is identical to the first message digest.

6. A method according to claim 3, wherein the second hash operation comprises:
a Secure Hash Algorithm (SHA), and wherein the second hash value comprises a second message digest which is identical to the first message digest.

7. A method according to claim 6, wherein the Secure Hash Algorithm (SHA), comprises:
a Secure Hash Algorithm-1 (SHA-1).

8. A method according to claim 3, wherein the second hash operation comprises:
a keyed Secure Hash Algorithm (SHA) operation, and wherein the second hash value comprises a keyed hash value.

9. A method according to claim 8, wherein the Secure Hash Algorithm (SHA), comprises:
a Secure Hash Algorithm-1 (SHA-1).

10. A method according to claim 1, wherein performing a second hash operation, comprises:
providing a key;
performing a second hash operation on the copied information, the first hash value and the key to generate the second hash value which proves integrity of the first hash value; and
signing the second hash value with the key to generate a keyed hash.

11. A method according to claim 1, wherein changing the copied information results in the second hash value no longer matching the first hash value.

12. A method according to claim 1, wherein changing the first hash value results in the second hash value no longer matching the first hash value.

13. A computer-readable medium having stored thereon a data structure, the data structure comprising:
a first field comprising copied information, wherein the copied information comprises a copy of original information from an information source;
a second field comprising a first hash value of the copied information which proves integrity of the copied information; and
a third field comprising a second hash value comprising a cryptographic hash of the first hash value and the copied information, wherein the second hash value simultaneously allows authenticity of copied information and the first hash value to be confirmed, and wherein the second hash value proves integrity of the first hash value.

14. A data structure according to claim 13, wherein the information source comprises a hard drive, wherein the original information comprises information stored on the hard drive, and wherein the copied information comprises a hard drive image file.

15. A data structure according to claim 13, wherein the first hash value comprises a first message digest.

16. A data structure according to claim 15, wherein the second hash value comprises a second message digest which is identical to the first message digest.

17. A data structure according to claim 15, wherein the second hash value comprises keyed hash value.

18. A data structure according to claim 13, wherein changing the copied information results in the second hash value no longer matching the first hash value.

19. A data structure according to claim 13, wherein changing the first hash value results in the second hash value no longer matching the first hash value.
